(19) United States
(12) Patent Application Publication
(10) Pub. No.: US 2018/0122561 A1
(43) Pub. Date: May 3, 2018

(54) TRANSFORMER

(71) Applicant: Realtek Semiconductor Corporation, Hsinchu (TW)

(72) Inventors: Hsiao-Tsung YEN, Hsinchu City (TW); Yuh-Sheng JEAN, Hsinchu County (TW); Ta-Hsun YEH, Hsinchu City (TW)

(21) Appl. No.: 15/684,903

(22) Filed: Aug. 23, 2017

(30) Foreign Application Priority Data
Nov. 2, 2016 (TW) 105135564

(51) Int. Cl. H01F 27/29; H01F 27/28

(52) U.S. Cl. CPC H01F 27/29; H01F 27/2828

(57) ABSTRACT

A transformer includes an input terminal, an output terminal, a first wire, and a second wire. The input and output terminals are disposed at two sides of the transformer with respect to a middle point of the transformer. The two sides of the transformer are opposite to each other. On the basis of a middle line which is disposed between the input terminal and the output terminal and passes through the middle point of the transformer, the two opposite sides include a first side and a second side which are disposed at opposite sides of the middle line. The first wire is winded to form circles. The second wire is winded correspondingly to the first wire to form circles. The first wire and/or the second wire are winded in an interlaced manner at location of the input terminal, location of the output terminal, the first side, and the second side.

### RELATED APPLICATIONS

This application claims priority to Taiwan Application Serial Number 105135564, filed Nov. 2, 2016, which is herein incorporated by reference.

### BACKGROUND OF THE INVENTION

### Field of Invention

The present invention relates to a power transforming technology. More particularly, the present invention relates to a transformer.

### Description of Related Art

Performance of a conventional spiral transformer is usually affected because the structure of the spiral transformer is not symmetrical. Specifically, if each of the transformers is formed of a plurality of circles whose structure are not symmetrical, the inductance of each of the transformers will be different thereby affecting the efficiency of the transformers.

In addition, if the circles of the spiral transformer are arranged in a stack manner, the quality value of the spiral transformer may be decreased. Furthermore, if the transformer is arranged in 8-shaped, the area of the transformer is large and the occupied space of the transformer in a device is large as well.

In view of the foregoing, problems and disadvantages are associated with existing products that require further improvement. However, those skilled in the art have yet to find a solution.

### SUMMARY OF THE INVENTION

One aspect of the present disclosure is directed to a transformer. The transformer comprises an input terminal, an output terminal, a first wire, and a second wire. The input terminal and the output terminal are respectively disposed at two opposite sides of the transformer with respect to a middle point of the transformer. On the basis of a middle line which is disposed between the input terminal and the output terminal and passes through the middle point of the transformer, the two opposite sides comprise a first side and a second side which are disposed at opposite sides of the middle line. The first wire is winded to form a plurality of circles. The second wire is winded correspondingly to the first wire to form a plurality of circles. The first wire and/or the second wire are winded in an interlaced manner at location of the input terminal, location of the output terminal, the first side, and the second side.

In view of the foregoing, embodiments of the present disclosure provide a transformer. Since the structure of the transformer is symmetrical, the problem of performance of a conventional spiral transformer being affected because the structure of the spiral transformer is not symmetrical can be solved. In addition, compared with the transformer with 8-shaped, the area of the transformer of the present disclosure is smaller so as to reduce the space of the device adopting the transformer.

### BRIEF DESCRIPTION OF THE DRAWINGS

The invention can be more fully understood by reading the following detailed description of the embodiment, with reference made to the accompanying drawings as follows:

FIG. 1 is a schematic diagram of a transformer according to some embodiments of the present disclosure.

FIG. 2 is a schematic diagram of a transformer according to some embodiments of the present disclosure.

FIG. 3 is a schematic diagram of a transformer according to some embodiments of the present disclosure.

FIG. 4 is a schematic diagram of a transformer according to some embodiments of the present disclosure.

FIG. 5 depicts an experimental data diagram of a transformer according to some embodiments of this disclosure.

### DETAILED DESCRIPTION

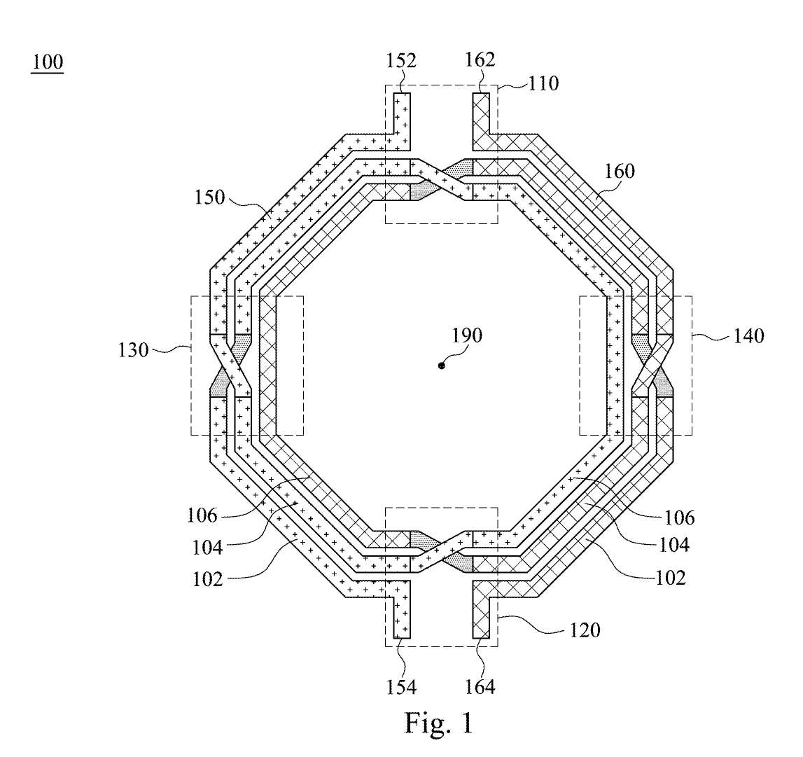

FIG. 1 is a schematic diagram of a transformer 100 according to some embodiments of the present disclosure. As shown in the figure, the transformer 100 comprises an input terminal 110, an output terminal 120, a first side 130, a second side 140, a first wire 150 and a second wire 160.

With respect to structure, the input terminal 110 and the output terminal 120 are respectively disposed at two opposite sides (i.e., the upper side and the lower side) of the transformer 100 with respect to a middle point 190 of the transformer 100. In addition, on the basis of a middle line which is disposed between the input terminal 110 and the output terminal 120 and passes through the middle point 190 of the transformer 100, the two opposite sides comprise a first side 130 and a second side 140 (i.e., the left side and the right side) which are disposed at opposite sides of the middle line. The first wire 150 is winded to form a plurality of circles, and the second wire 160 is winded correspondingly to the first wire 150 to form a plurality of circles. As shown in the figure, the first wire 150 and/or the second wire 160 are winded in an interlaced manner at location of the input terminal 110, location of the output terminal 120, the first side 130, and the second side 140. In view of the above, the structure of the present disclosure is extremely symmetrical. Specifically, an inductor which is formed by the first wire 150 and an inductor which is formed by the second wire 160 are symmetrical, such that it facilitates reducing noise of the transformer 100 and enhance the performance of the transformer 100.

In one embodiment, the first wire 150 and the second wire 160 are disposed on the same layer. In another embodiment, the first wire 150 and the second wire 160 are wired together to form the transformer 100 with odd number circles. The first wire 150 comprises a first terminal 152 and a second terminal 154, and the second wire 160 comprises a first terminal 162 and a second terminal 164. With respect to structure, the first terminals 152, 162 of the first wire 150 and the second wire 160 are located at the input terminal 110 of the transformer 100, and the second terminals 154, 164 of the first wire 150 and the second wire 160 are located at the output terminal 120 of the transformer 100.

As can be seen in the figure, the first wire 150 is winded with itself in an interlaced manner at the first side 130, and winded with the second wire 160 in an interlaced manner at location of the input terminal 110 and location of the output terminal 120. The second wire 160 is winded with itself in an interlaced manner at the second side 140. Specifically, the transformer 100 comprises a first circle 102, a second circle 104 and a third circle 106. The first wire 150 is wired around the middle point 190, and is wired from the first terminal 152 along the first circle 102. The first wire 150 is continuously wired into the second circle 104 at the first side 130 in an interlaced manner. The first wire 150 is continuously wired along the second circle 104 and is wired into the third circle 106 at location of the output terminal 120 in an interlaced manner. In addition, the first wire 150 is continuously wired along the third circle 106 and is wired into the second circle 104 at location of the input terminal 110 in an interlaced manner. The first wire 150 is continuously wired along the second circle 104 and is wired into the first circle 102 at the first side 130 in an interlaced manner. Finally, the second terminal 154 of the first wire 150 is wired out at the output terminal 120.

Accordingly, the second wire 160 is wired around the middle point 190, and is wired from the first terminal 162 along the first circle 102. The second wire 160 is continuously wired into the second circle 104 at the second side 140 in an interlaced manner. The second wire 104 is continuously wired along the second circle 104 and is wired into the third circle 106 at location of the output terminal 120 in an interlaced manner. In addition, the second wire 160 is continuously wired along the third circle 106 and is wired into the second circle 104 at location of the input terminal 110 in an interlaced manner. The second wire 160 is continuously wired along the second circle 104 and is wired into the first circle 102 at the second side 140 in an interlaced manner. Finally, the second terminal 164 of the second wire 160 is wired out at the output terminal 120. In the embodiment, the first circle 102, the second circle 104 and the third circle 106 are disposed in a sequence from outside to inside. However, the present disclosure is not limited to the embodiment of FIG. 1, and it is merely illustrated for explanation purpose.

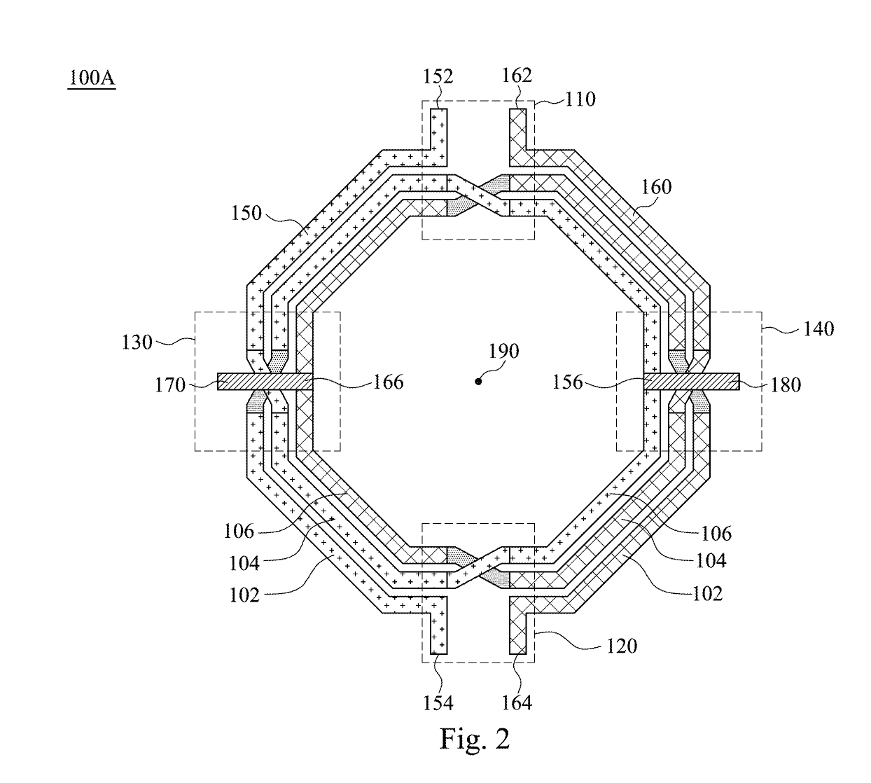

FIG. 2 is a schematic diagram of a transformer 100A according to embodiments of the present disclosure. Compared with the transformer 100 illustrated in FIG. 1, the transformer 100A herein further comprises a first center tap 170 and a second center tap 180. With respect to structure, the first center tap 170 is coupled to the second wire 160 located at the first side 130 (i.e., the first center tap 170 is coupled to the connection point 166 of the second wire 160), and the second center tap 180 is coupled to the first wire 150 located at the second side 140 (i.e., the second center tap 180 is coupled to the connection point 156 of the first wire 150). However, the present disclosure is not limited to the embodiment of FIG. 2, and it is merely illustrated for explanation purpose.

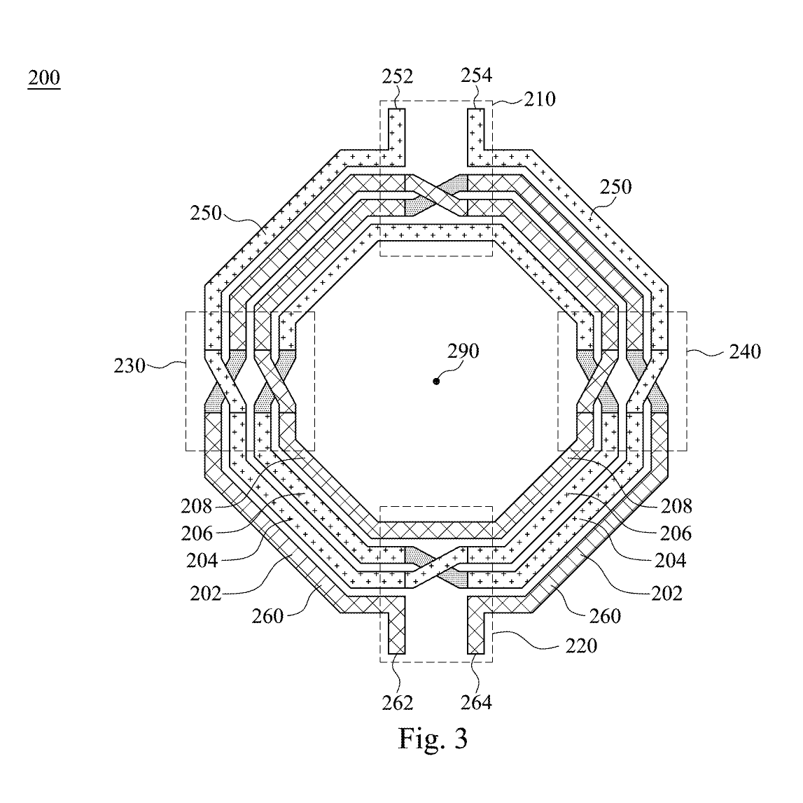

FIG. 3 is a schematic diagram of a transformer 200 according to some embodiments of the present disclosure. In contrast to the transformer 100 with odd number circles as illustrated in FIG. 1, the transformer 200 herein are formed by wiring the first wire 250 and the second wire 260 together with even number circles. As illustrated in FIG. 3, the first wire 250 comprise a first terminal 252 and a second terminal 254, and the second wire 260 comprise a first terminal 262 and a second terminal 264. With respect to structure, the first terminal 252 and the second terminal 254 of the first wire 250 are located at the input terminal 210 of the transformer 200, and the first terminal 262 and the second terminal 264 of the second wire 260 are located at the output terminal 220 of the transformer 200. Since the first wire 250 can be regard as wired in and wired out from the same terminal (i.e., the input terminal 210), and the second wire 260 can be regard as wired in and wired out from the same terminal (i.e., the output terminal 220), it is easy to design the transformer 200 together with other elements to form an entire structure/device.

As can be seen in the figure, the first wire 250 and the second wire 260 are winded in an interlaced manner at the first side 230 and the second side 240. The first wire 250 is winded with itself in an interlaced manner at location of the output terminal 220, and the second wire 260 is winded with itself in an interlaced manner at location of the input terminal 210. Specifically, the transformer 200 comprises a first circle 202, a second circle 204, a third circle 206 and a fourth circle 208. The first wire 250 is wired around the middle point 290, and is wired from the first terminal 252 along the first circle 202. The first wire 250 is continuously wired into the second circle 204 at the first side 230 in an interlaced manner. The first wire 250 is continuously wired along the second circle 204 and is wired into the third circle 206 at location of the output terminal 220 in an interlaced manner. The first wire 250 is continuously wired along the third circle 206 and is wired into the fourth circle 208 at the second side 240 in an interlaced manner. In addition, the first wire 250 is continuously wired along the fourth circle 208 and is wired into the third circle 206 at the first side 230 in an interlaced manner. The first wire 250 is continuously wired along the third circle 206 and is wired into the second circle 204 at location of the output terminal 220 in an interlaced manner. The first wire 250 is continuously wired along the second circle 204 and is wired into the first circle 202 at the second side 240 in an interlaced manner. Finally, the second terminal 254 of the first wire 250 is wired out at the input terminal 210.

Accordingly, the second wire 260 is wired around the middle point 290, and is wired from the first terminal 262 along the first circle 202. The second wire 260 is continuously wired into the second circle 204 at the first side 230 in an interlaced manner. The second wire 260 is continuously wired along the second circle 204 and is wired into the third circle 206 at location of the input terminal 210 in an interlaced manner. The second wire 260 is continuously wired along the third circle 206 and is wired into the fourth circle 208 at the second side 240 in an interlaced manner. In addition, the second wire 260 is continuously wired along the fourth circle 208 and is wired into the third circle 206 at the first side 230 in an interlaced manner. The second wire 260 is continuously wired along the third circle 206 and is wired into the second circle 204 at location of the input terminal 210 in an interlaced manner. The second wire 260 is continuously wired along the second circle 204 and is wired into the first circle 202 at the second side 240 in an interlaced manner. Finally, the second terminal 264 of the second wire 260 is wired out at the output terminal 220. In the embodiment, the first circle 202, the second circle 204, the third circle 206, and the fourth circle 208 are disposed in a sequence from outside to inside. However, the present disclosure is not limited to the embodiment of FIG. 3, and it is merely illustrated for explanation purpose.

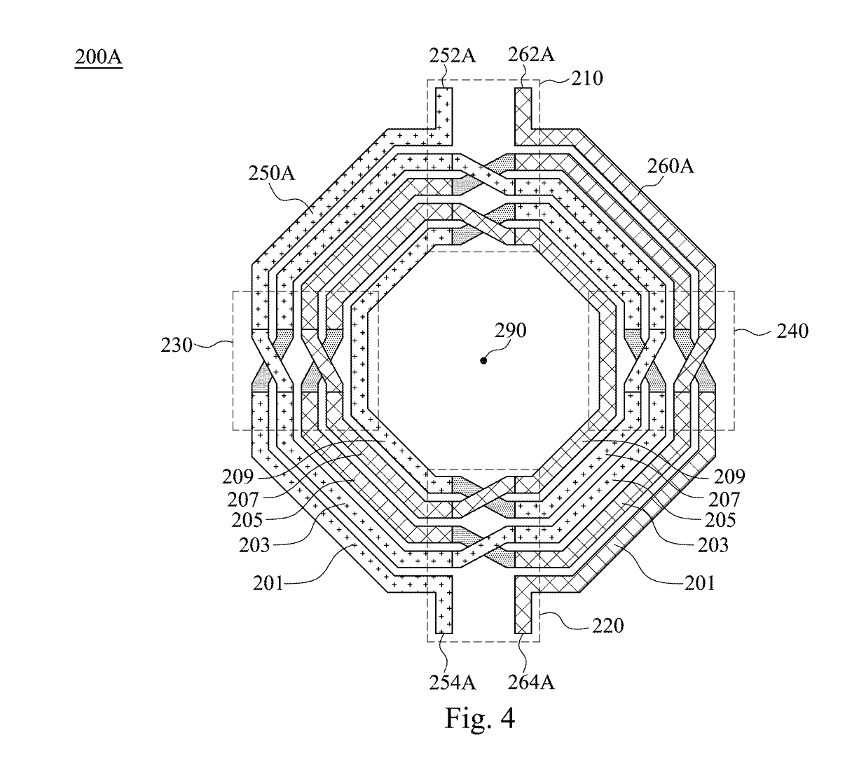

FIG. 4 is a schematic diagram of a transformer 200A according to some embodiments of the present disclosure. It is noted that although the transformer 200A of FIG. 4 and the transformer 100 of FIG. 1 are wired to form transformers with odd number circles, the transformer 200A of FIG. 4 has more circles. Specifically, the transformer 200A comprises a first circle 201, a second circle 203, a third circle 205, a fourth circle 207, and a fifth circle 209. The first wire 250A is wired around the middle point 290, and is wired from the first terminal 252A along the first circle 201. The first wire 250A is continuously wired into the second circle 203 at the first side 230 in an interlaced manner. The first wire 205A is continuously wired along the second circle 203 and is wired into the third circle 205 at location of the output terminal 220 in an interlaced manner. In addition, the first wire 250A is continuously wired along the third circle 205 and is wired into the fourth circle 207 at the second side 240 in an interlaced manner. The first wire 250A is continuously wired along the fourth circle 207 and is wired into the fifth circle 209 at location of the input terminal 210 in an interlaced manner. Besides, the first wire 250A is wired along the fifth circle 209 and is wired into the fourth circle 207 at location of the output terminal 220 in an interlaced manner. The first wire 250A is continuously wired along the fourth circle 207 and is wired into the third circle 205 at the second side 240 in an interlaced manner. The first wire 250A is continuously wired along the third circle 205 and is wired into the second circle 203 at location of the input terminal 210 in an interlaced manner. The first wire 250A is continuously wired along the second circle 203 and is wired into the first circle 201 at the first side 230 in an interlaced manner. Finally, the second terminal 254A of the first wire 250A is wired out at the output terminal 220.

Accordingly, the second wire 260A is wired around the middle point 290, and is wired from the first terminal 262A along the first circle 201. The second wire 260 is continuously wired into the second circle 203 at the second side 240 in an interlaced manner. The second wire 260A is continuously wired along the second circle 203 and is wired into the third circle 205 at location of the output terminal 220 in an interlaced manner. The second wire 260A is continuously wired along the third circle 205 and is wired into the fourth circle 207 at the first side 230 in an interlaced manner. In addition, the second wire 260A is continuously wired along the fourth circle 207 and is wired into the fifth circle 209 at location of the input terminal 210 in an interlaced manner. Besides, the second wire 260A is wired along the fifth circle 209 and is wired into the fourth circle 207 at location of the output terminal 220 in an interlaced manner. The second wire 260A is continuously wired along the fourth circle 207 and is wired into the third circle 205 at the first side 230 in an interlaced manner. The second wire 260A is continuously wired along the third circle 205 and is wired into the second circle 203 at location of the input terminal 210 in an interlaced manner. The second wire 260A is continuously wired along the second circle 203 and is wired into the first circle 201 at the second side 240 in an interlaced manner. Finally, the second terminal 264A of the second wire 260A is wired out at the output terminal 220. In the embodiment, the first circle 201, the second circle 203, the third circle 205, the fourth circle 207, and the fifth circle 209 are disposed in a sequence from outside to inside. However, the present disclosure is not limited to the embodiment of FIG. 4, and it is merely illustrated for explanation purpose.

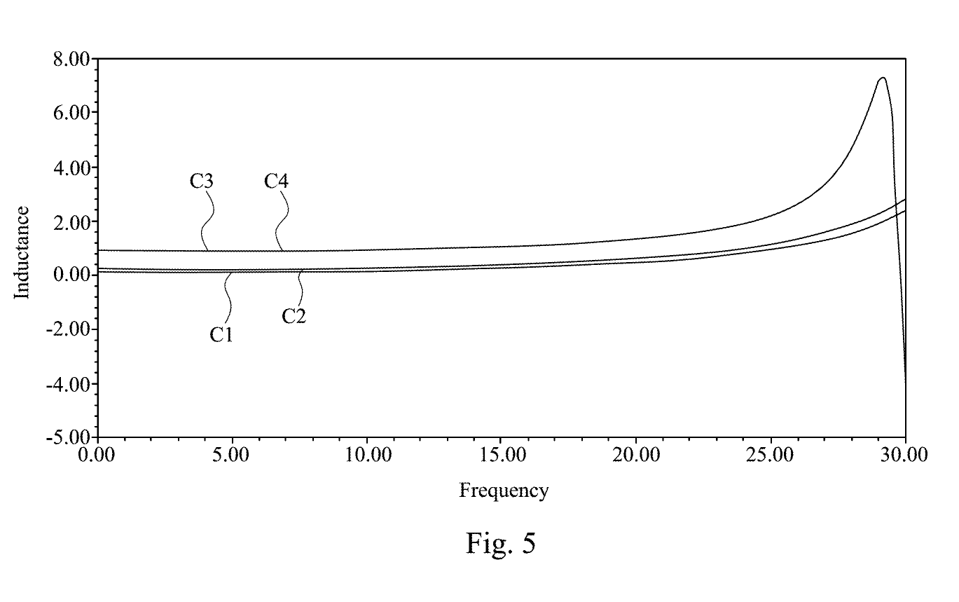

FIG. 5 depicts an experimental data diagram of a transformer according to some embodiments of this disclosure. This experimental data diagram is used for describing the inductance of the transformer when the transformer operates in different frequencies. As shown in the figure, the curves C1, C2 represent an experimental data if the structure of the transformer is not symmetrical. The curve C1 represents the inductance of one of the inductors in the transformer, and the curve C2 represents the inductance of another one of the inductors in the transformer. As can be seen in the experimental data of FIG. 5, the inductance of the two inductors in the transformer are not symmetrical. The curves C3, C4 represent an experimental data if the structure of the transformer in the present disclosure is symmetrical. The curve C3 represents the inductance of one of the inductors in the transformer, and the curve C4 represents the inductance of another one of the inductors in the transformer. As can be seen in the experimental data of FIG. 5, the inductance of the two inductors in the transformer are extremely symmetrical. In contrast to the structure of the transformer being not symmetrical, the inductance of the two inductors in the transformer is extremely symmetrical. Hence, the transformer of the embodiments of the present disclosure can reduce the noise and enhance the performance of the transformer. However, the present disclosure is not limited to the values as shown in the embodiments, a person skilled in the art may change the values for achieving the best efficiency.

In view of the above embodiments of the present disclosure, it is apparent that the application of the present invention has the advantages as follows. Embodiments of the present disclosure provide a transformer. Since the structure of the transformer is symmetrical, the problem of the performance of a conventional spiral transformer being affected because the structure of the spiral transformer is not symmetrical can be solved. In addition, compared with the transformer with 8-shaped, the area of the transformer of the present disclosure is smaller so as to reduce the space of the device adopting the transformer.

What is claimed is:

1. A transformer, comprise:
an input terminal and an output terminal respectively disposed at two opposite sides of a transformer with respect to a middle point of the transformer, wherein on the basis of a middle line which is disposed between the input terminal and the output terminal and passes through the middle point of the transformer, the two opposite sides comprise a first side and a second side which are disposed at opposite sides of the middle line;
a first wire winded to form a plurality of circles; and
a second wire, winded correspondingly to the first wire to form a plurality of circles, wherein the first wire and/or the second wire are winded in an interlaced manner at location of the input terminal location, location of the output terminal location, the first side, and the second side.

2. The transformer of claim 1, wherein the first wire and the second wire are disposed on the same layer.

3. The transformer of claim 2, wherein the first wire and the second wire are wired together to form the transformer with odd number circles.

4. The transformer of claim 3, wherein the first wire and the second wire respectively comprise a first terminal and a second terminal, the first terminals of the first wire and the second wire are located at the input terminal of the transformer, and the second terminals of the first wire and the second wire are located at the output terminal of the transformer.

5. The transformer of claim 4, wherein the first wire is winded with itself in an interlaced manner at the first side, and winded with the second wire in an interlaced manner at location of the input terminal and location of the output terminal, wherein the second wire is winded with itself in an interlaced manner at the second side.

6. The transformer of claim 5, wherein the transformer comprise a first circle, a second circle and a third circle, wherein the first wire is wired from the first terminal along the first circle and is wired into the second circle at the first side in an interlaced manner, wherein the first wire is continuously wired along the second circle and is wired into the third circle at location of the output terminal in an interlaced manner, wherein the first wire is continuously wired along the third circle and is wired into the second circle at location of the input terminal in an interlaced manner, wherein the first wire is continuously wired along the second circle and is wired into the first circle at the first side in an interlaced manner.

7. The transformer of claim 6, wherein the second wire is wired from the first terminal along the first circle and is wired into the second circle at the second side in an interlaced manner, wherein the second wire is continuously wired along the second circle and is wired into the third circle at location of the output terminal in an interlaced manner, wherein the second wire is continuously wired along the third circle and is wired into the second circle at location of the input terminal in an interlaced manner, wherein the second wire is continuously wired along the second circle and is wired into the first circle at the second side in an interlaced manner.

8. The transformer of claim 6, wherein the first circle, the second circle, and the third circle are disposed in a sequence from outside to inside.

9. The transformer of claim 8, further comprising:
a first center tap, coupled to the second wire located at the first side; and
a second center tap, coupled to the first wire located at the second side.

10. The transformer of claim 5, wherein the transformer comprise a first circle, a second circle, a third circle, a fourth circle and a fifth circle, wherein the first wire is wired from the first terminal along the first circle and is wired into the second circle at the first side in an interlaced manner, wherein the first wire is continuously wired along the second circle and is wired into the third circle at location of the output terminal in an interlaced manner, wherein the first wire is continuously wired along the third circle and is wired into the fourth circle at the second side in an interlaced manner, wherein the first wire is continuously wired along the fourth circle and is wired into the fifth circle at location of the input terminal in an interlaced manner.

11. The transformer of claim 10, wherein the first wire is wired along the fifth circle and is wired into the fourth circle at location of the output terminal in an interlaced manner, wherein the first wire is continuously wired along the fourth circle and is wired into the third circle at the second side in an interlaced manner, wherein the first wire is continuously wired along the third circle and is wired into the second circle at location of the input terminal in an interlaced manner, wherein the first wire is continuously wired along the second circle and is wired into the first circle at the first side in an interlaced manner.

12. The transformer of claim 11, wherein the second wire is wired from the first terminal along the first circle and is wired into the second circle at the second side in an interlaced manner, wherein the second wire is continuously wired along the second circle and is wired into the third circle at location of the output terminal in an interlaced manner, wherein the second wire is continuously wired along the third circle and is wired into the fourth circle at the first side in an interlaced manner, wherein the second wire is continuously wired along the fourth circle and is wired into the fifth circle at location of the input terminal in an interlaced manner.

13. The transformer of claim 12, wherein the second wire is wired along the fifth circle and is wired into the fourth circle at location of the output terminal in an interlaced manner, wherein the second wire is continuously wired along the fourth circle and is wired into the third circle at the first side in an interlaced manner, wherein the second wire is continuously wired along the third circle and is wired into the second circle at location of the input terminal in an interlaced manner, wherein the second wire is continuously wired along the second circle and is wired into the first circle at the second side in an interlaced manner.

14. The transformer of claim 10, wherein the first circle, the second circle, the third circle, the fourth circle, and the fifth circle are disposed in a sequence from outside to inside.

15. The transformer of claim 2, wherein the first wire and the second wire are wired together to form the transformer with even number circles.

16. The transformer of claim 15, wherein the first wire and the second wire respectively comprise a first terminal and a second terminal, wherein the first terminal and the second terminal of the first wire are located at the input terminal of the transformer, and the first terminal and the second terminal of the second wire are located at the output terminal of the transformer.

17. The transformer of claim 16, wherein the first wire and the second wire are winded in an interlaced manner at the first side and the second side, wherein the first wire is winded with itself in an interlaced manner at location of the output terminal, and the second wire is winded with itself in an interlaced manner at location of the input terminal.

18. The transformer of claim 17, wherein the transformer comprises a first circle, a second circle, a third circle, and a fourth circle, wherein the first wire is wired from the first terminal along the first circle and is wired into the second circle at the first side in an interlaced manner, wherein the first wire is continuously wired along the second circle and is wired into the third circle at location of the output terminal in an interlaced manner, wherein the first wire is continuously wired along the third circle and is wired into the fourth circle at the second side in an interlaced manner, wherein the first wire is continuously wired along the fourth circle and is wired into the third circle at the first side in an interlaced manner, wherein the first wire is continuously wired along the third circle and is wired into the second circle at location of the output terminal in an interlaced manner, wherein the first wire is continuously wired along the second circle and is wired into the first circle at the second side in an interlaced manner.

19. The transformer of claim 18, wherein the second wire is wired from the first terminal along the first circle and is wired into the second circle at the first side in an interlaced manner, wherein the second wire is continuously wired along the second circle and is wired into the third circle at location of the input terminal in an interlaced manner, wherein the second wire is continuously wired along the third circle and is wired into the fourth circle at the second side in an interlaced manner, wherein the second wire is continuously wired along the fourth circle and is wired into the third circle at the first side in an interlaced manner, wherein the second wire is continuously wired along the third circle and is wired into the second circle at location of the input terminal in an interlaced manner, wherein the second wire is continuously wired along the second circle and is wired into the first circle at the second side in an interlaced manner.

20. The transformer of claim 18, wherein the first circle, the second circle, the third circle, and the fourth circle are disposed in a sequence from outside to inside.
